(19) United States
(12) Patent Application Publication
(10) Pub. No.: US 2009/0091539 A1
(43) Pub. Date: Apr. 9, 2009

(54) Sending A Document For Display To A User Of A Surface Computer

(75) Inventors: Lydia M. Do, Raleigh, NC (US); Pamela A. Nesbitt, Tampa, FL (US); Lisa A. Seacat, San Francisco, CA (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 11/868,766

(22) Filed: Oct. 8, 2007

(51) Int. Cl. G06F 3/041

(52) U.S. Cl. 345/173

(57) ABSTRACT

Methods, apparatus, and products are disclosed for sending a document for display to a user of a surface computer, the surface computer comprising a surface, surface computer capable receiving multi-touch input through the surface and rendering display output on the surface, that include: registering at least two users with the surface computer, the users including a sender and a receiver; allocating to each registered user a portion of the surface for interaction between the registered user and the surface computer; receiving, from the sender, a user selection specifying a document; receiving, from the sender, a sending instruction to send the selected document to the receiver for display; and rendering, in response to receiving the sending instruction, contents of the selected document on the receiver's allocated portion of the surface.

### BACKGROUND OF THE INVENTION

1. Field of the Invention

The field of the invention is data processing, or, more specifically, methods, apparatus, and products for sending a document for display to a user of a surface computer.

2. Description of Related Art

Multi-touch surface computing is an area of computing that has made tremendous advancements over the last few years. Multi-touch surface computing allows a user to interact with a computer through a surface that is typically implemented as a table top. The computer renders a graphical user interface (‘GUI’) on the surface and users may manipulate GUI objects directly with their hands using multi-touch technology as opposed to using traditional input devices such as a mouse or a keyboard. In such a manner, the devices through which users provide input and receive output are merged into a single surface, which provide an intuitive and efficient mechanism for users to interact with the computer. As surface computing becomes more ubiquitous in everyday environments, readers will appreciate advancements in how users may utilize surface computing to intuitively and efficiently perform tasks that may be cumbersome using traditional input devices such as a keyboard and mouse. Specifically, readers will appreciate advancements in sending a document for display to a user of a surface computer.

### SUMMARY OF THE INVENTION

Methods, apparatus, and products are disclosed for sending a document for display to a user of a surface computer, the surface computer comprising a surface, surface computer capable receiving multi-touch input through the surface and rendering display output on the surface, that include: registering at least two users with the surface computer, the users including a sender and a receiver; allocating to each registered user a portion of the surface for interaction between the registered user and the surface computer; receiving, from the sender, a user selection specifying a document; receiving, from the sender, a sending instruction to send the selected document to the receiver for display; and rendering, in response to receiving the sending instruction, contents of the selected document on the receiver's allocated portion of the surface.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary surface computer capable of sending a document for display to a user according to embodiments of the present invention.

FIG. 2A sets forth a line drawing illustrating an exemplary surface useful in sending a document for display to a user of a surface computer according to embodiments of the present invention.

FIG. 2B sets forth a line drawing illustrating a further exemplary surface useful in sending a document for display to a user of a surface computer according to embodiments of the present invention.

FIG. 2C sets forth a line drawing illustrating a further exemplary surface useful in sending a document for display to a user of a surface computer according to embodiments of the present invention.

FIG. 3 sets forth a flow chart illustrating an exemplary method of sending a document for display to a user of a surface computer according to embodiments of the present invention.

### DETAILED DESCRIPTION OF EXEMPLARY EMBODIMENTS

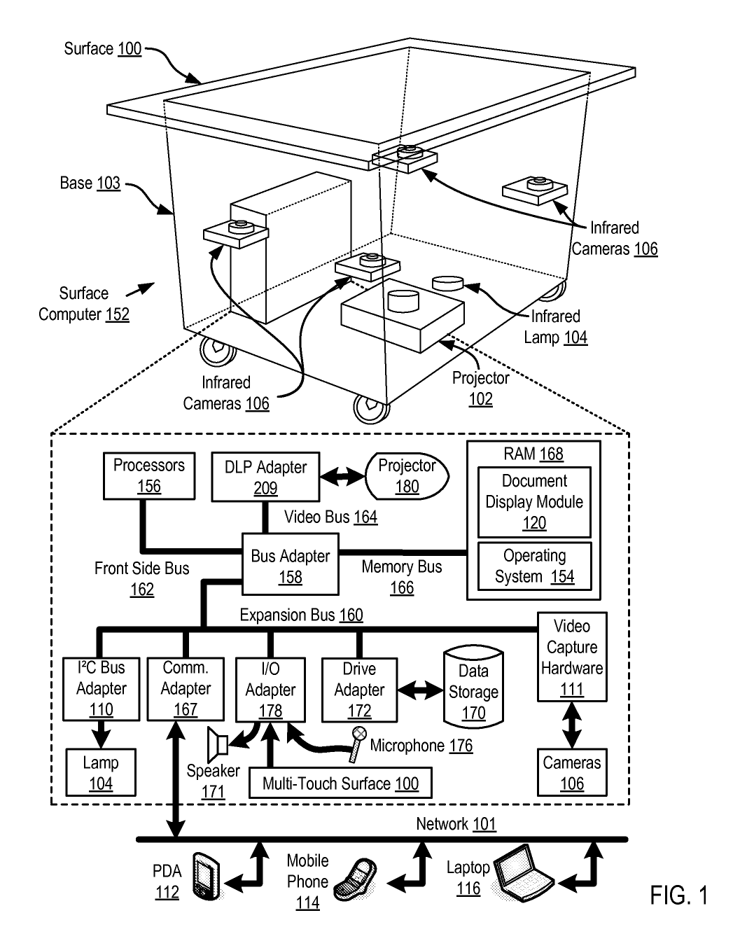

Exemplary methods, apparatus, and products for sending a document for display to a user of a surface computer in accordance with the present invention are described with reference to the accompanying drawings, beginning with FIG. 1. FIG. 1 sets forth a functional block diagram of an exemplary surface computer (152) capable of displaying documents to a plurality of users according to embodiments of the present invention. The exemplary surface computer (152) of FIG. 1 includes a surface (100) mounted atop a base (103) that houses the other components of the surface computer (152). The surface (100) may be implemented using acrylic, glass, or other materials as will occur to those of skill in the art. In addition to the computing functionality provided by the surface computer (152), the surface (100) of FIG. 1 may also serve as a table top for a coffee table, dining table, a conference table, or some other table as will occur those of skill in the art. Examples of a surface computer that may be improved for sending a document for display to a user according to embodiments of the present invention may include the Microsoft Surface™ and the ROSIE Coffee Table by Savant.

The exemplary surface computer (152) of FIG. 1 is capable of receiving multi-touch input through the surface (100) and rendering display output on the surface (100). Multi-touch input refers to the ability of the surface computer (152) to recognize multiple simultaneous points of contact between objects and the surface (100). These objects may include hands, fingers, portable electronic devices, papers, cups, plates, or any other object as will occur to those of skill in the art. Such recognition may include the position and pressure or degree of each point of contact, which allows gestures and interaction with multiple fingers or hands through intuitive gestures. Depending largely on the size of the surface, a surface computer typically supports interaction with more than one user or object simultaneously. In the example of FIG. 1, the surface computer (100) supports interaction with a plurality of users.

In the example of FIG. 1, the exemplary surface computer (152) receives multi-touch input through the surface (100) by reflecting infrared light off of objects on top of the surface (100) and capturing the reflected images of the objects using multiple infrared cameras (106) mounted inside the base (103). Using the reflected infrared images, the surface computer (100) may then perform pattern matching to determine the type of objects that the images represent. The objects may include fingers, hands, portable electronic devices, papers, and so on. The infrared light used to generate the images of the objects is provided by an infrared lamp (104) mounted to the base (103) of the surface computer (152). Readers will note that infrared light may be used to prevent any interference with users' ability to view the surface (100) because infrared light is typically not visible to the human eye.

Although the exemplary surface computer (152) of FIG. 1 above receives multi-touch input through the surface (100) using a system of infrared lamps and cameras, readers will note that such implementation are for explanation only and not for limitation. In fact, other embodiments of a surface computer for displaying documents to a plurality of users according to embodiments of the present invention may use other technologies as will occur to those of skill in the art such as, for example, frustrated total internal reflection. Frustrated total internal reflection refers to a technology that disperses light through a surface using internal reflection. When an object comes in contact with one side of the surface, the dispersed light inside the surface scatters onto light detectors on the opposite side of the surface, thereby identifying the point at which the object touched the surface. Other technologies may include dispersive signal technology and acoustic pulse recognition.

In the example of FIG. 1, the surface computer (152) renders display output on the surface (100) using a projector (102). The projector (102) renders a GUI on the surface (100) for viewing by the users. The projector (102) of FIG. 1 is implemented using Digital Light Processing (‘DLP’) technology originally developed at Texas Instruments. Other technologies useful in implementing the projector (102) may include liquid crystal display (‘LCD’) technology and liquid crystal on silicon (‘LCOS’) technology. Although the exemplary surface computer (152) of FIG. 1 above displays output on the surface (100) using a projector (102), readers will note that such an implementation is for explanation and not for limitation. In fact, other embodiments of a surface computer for displaying documents to a plurality of users according to embodiments of the present invention may use other technologies as will occur to those of skill in the art such as, for example, embedding a flat panel display into the surface (100).

The surface computer (152) of FIG. 1 includes one or more computer processors (156) as well as random access memory (‘RAM’) (168). The processors (156) are connected to other components of the system through a front side bus (162) and bus adapter (158). The processors (156) are connected to RAM (168) through a high-speed memory bus (166) and to expansion components through an extension bus (168).

Stored in RAM (156) is a document display module (120), software that includes computer program instructions for sending a document for display to a user of the surface computer (152) according to embodiments of the present invention. The document display module (120) operates generally for sending a document for display to a user of the surface computer (152) according to embodiments of the present invention by: registering at least two users with the surface computer, the users including a sender and a receiver; allocating to each registered user a portion of the surface for interaction between the registered user and the surface computer; receiving, from the sender, a user selection specifying a document; receiving, from the sender, a sending instruction to send the selected document to the receiver for display; and rendering, in response to receiving the sending instruction, contents of the selected document on the receiver's allocated portion of the surface. The document rendered on the surface (100) may include a word processing document, an image file, a video file, slide show presentation file, XML-based document, and so on. Readers will note that the document may be stored in volatile or non-volatile memory. Further, readers will note that in a preferred embodiment, the display surface (100) is sufficiently large to accommodate several individuals seated around the display surface such as, for example, when the surface computer serves as a conference table.

Also stored in RAM (168) is an operating system (154). Operating systems useful for applying sending a document for display to a user of a surface computer according to embodiments of the present invention may include or be derived from UNIX™, Linux™, Microsoft Vista™, Microsoft XP™, AIX™, IBM's i5/OS™, and others as will occur to those of skill in the art. The operating system (154) and the document display module (120) in the example of FIG. 1 are shown in RAM (168), but many components of such software typically are stored in non-volatile memory also, such as, for example, on a disk drive (170).

The surface computer (152) of FIG. 1 includes disk drive adapter (172) coupled through expansion bus (160) and bus adapter (158) to processor (156) and other components of the computing device (152). Disk drive adapter (172) connects non-volatile data storage to the computing device (152) in the form of disk drive (170). Disk drive adapters useful in computing devices for sending a document for display to a user of a surface computer according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (‘EEPROM’ or ‘Flash’ memory), RAM drives, and so on, as will occur to those of skill in the art.

The example surface computer (152) of FIG. 1 includes one or more input/output (‘I/O’) adapters (178). I/O adapters implement user-oriented input/output through, for example, software drivers and computer hardware for controlling output to devices such as computer display screens or speakers (171), as well as user input from user input devices such as, for example, microphone (176) for collecting speech input. The example surface computer (152) of FIG. 1 also includes a Digital Light Processing adapter (209), which is an example of an I/O adapter specially designed for graphic output to a projector (180). Video adapter (209) is connected to processor (156) through a high speed video bus (164), bus adapter (158), and the front side bus (162), which is also a high speed bus.

The exemplary surface computer (152) of FIG. 1 includes video capture hardware (111) that converts image signals received from the infrared cameras (106) to digital video for further processing, including pattern recognition. The video capture hardware (111) of FIG. 1 may use any number of video codec, including for example codec described in the Moving Picture Experts Group (‘MPEG’) family of specifications, the H.264 standard, the Society of Motion Picture and Television Engineers' 421M standard, or any other video codec as will occur to those of skill in the art. Although the video capture hardware (111) of FIG. 1 is depicted separately from the infrared cameras (106), readers will note that in some embodiment the video capture hardware (111) may be incorporated into the cameras (106). In such embodiments, the infrared camera (106) may connect to the other components of the surface computer through a Universal Serial Bus (‘USB’) connection, FireWire connection, or any other data communications connection as will occur to those of skill in the art.

The exemplary surface computer (152) of FIG. 1 also includes an Inter-Integrated Circuit (‘I²C’) bus adapter (110). The I²C bus protocol is a serial computer bus protocol for connecting electronic components inside a computer that was first published in 1982 by Philips. I²C is a simple, low-bandwidth, short-distance protocol. Through the I²C bus adapter (110), the processors (156) control the infrared lamp (104). Although the exemplary surface computer (152) utilizes the I²C protocol, readers will note this is for explanation and not for limitation. The bus adapter (110) may be implemented using other technologies as will occur to those of ordinary skill in the art, including for example, technologies described in the Intelligent Platform Management Interface (‘IPMI’) specification, the System Management Bus (‘SMBus’) specification, the Joint Test Action Group (‘JTAG’) specification, and so on.

The exemplary surface computer (152) of FIG. 1 also includes a communications adapter (167) that couples the surface computer (152) for data communications with other computing devices through a data communications network (101). Such a data communication network (100) may be implemented with external buses such as a Universal Serial Bus (‘USB’), or as an Internet Protocol (‘IP’) network or an Ethernet™ network, for example, and in other ways as will occur to those of skill in the art. Communications adapters implement the hardware level of data communications through which one computer sends data communications to another computer, directly or through a data communications network. Examples of communications adapters useful for sending a document for display to a user of a surface computer according to embodiments of the present invention include modems for wired dial-up communications, Ethernet (IEEE 802.3) adapters for wired data communications network communications and 802.11 adapters for wireless data communications network communications.

FIG. 1 illustrates several computing devices (112, 114, 116) connected to the surface computer (152) for data communications through a network (101). Data communication may be established when the Personal Digital Assistant (112), the mobile phone (114), and the laptop (116) a placed on top of the surface (100). Through the images of the computing devices (112, 114, 116), the surface computer (152) may identify each device (112, 114, 116) and configure a wireless data communications connections with each device. The contents of any documents contained in the devices (112, 114, 116) may be retrieved into the surface computer's memory and rendered on the surface (100) for interaction with surface computer's users.

The arrangement of networks and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

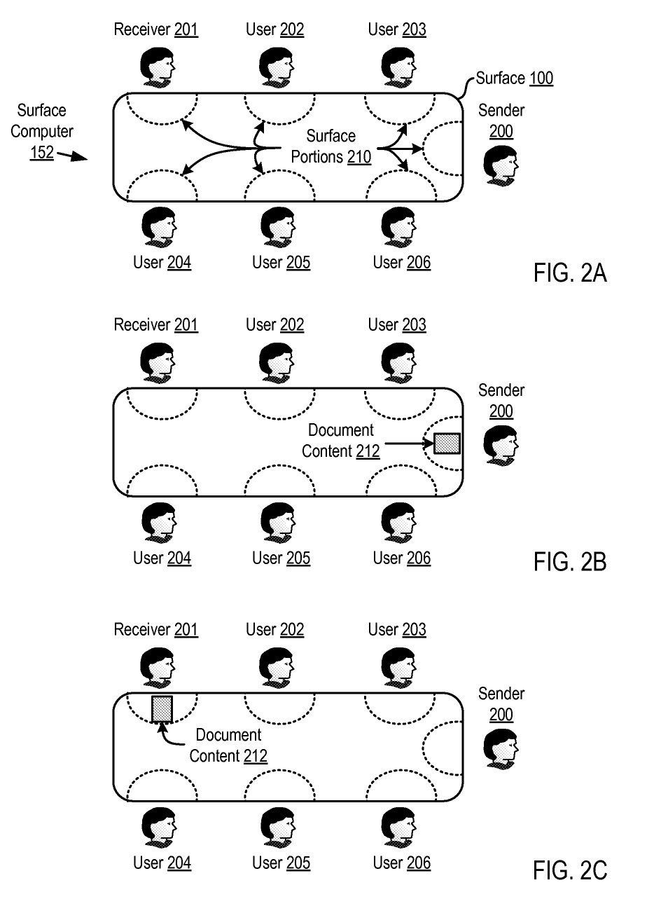

For further explanation, FIGS. 2A-C sets forth line drawings illustrating exemplary surfaces useful in sending a document for display to a user of a surface computer according to embodiments of the present invention. The surface (100) of FIGS. 2A-C is comprised in a surface computer (152). The surface computer is capable of receiving multi-touch input through the surface (100) and rendering display output on the surface (100).

In the examples of FIGS. 2A-C, several users (200-206) are positioned adjacent to the surface computer (152) for interaction through the surface (100). The users (200-206) include a sender (200) and a receiver (201). Each user (200-206) may choose their respective position around the surface computer (152) by choosing a chair in which to sit around the surface computer (152) or by merely standing near an edge of the surface (100). After the users (200-206) choose a location near the surface (100), the surface computer (152) registers the users (200-206) with the surface computer (152) and assigns a portion (210) of the surface (100) to each registered user (200-206) for interaction between that registered user (200-206) and the surface computer (152). Registering the users (200-206) with the surface computer (152) and allocating a portion (210) of the surface (100) to each registered user (200-206) is discussed in more detail below.

In the example of FIG. 2B, the surface computer (152) receives a user selection from the sender (200) that specifies a document for sending to the receiver (201). The surface computer (152) may receive the user selection when the sender (200) makes a particular hand gesture on the surface (100) or issues a particular voice command. Although at this point the document is typically stored in the surface computer's memory, the document may initially be stored in a portable computing device placed on the surface (100) of the surface computer (152). Upon detecting that the computing device is placed on the surface (100) of the surface computer (152), the surface computer (152) may establish a data communications connection with the portable computing device and retrieve the document from the computing device. In response to receiving the user selection, the surface computer (152) of FIG. 2B renders the contents (212) of the selected document on the sender's allocated portion of the surface (100).

In the example of FIG. 2C, the surface computer (152) receives a sending instruction from the sender (200) to send the selected document to the receiver (201) for display. The surface computer (152) may receive the sending instruction when the sender (200) makes a particular hand gesture on the surface (100) or issues a particular voice command. In response to receiving the sending instruction, the surface computer (152) renders the contents (212) of the selected document on the receiver's allocated portion of the surface (100). As part of rendering the contents (212) of the selected document on the receiver's allocated portion of the surface (100), the surface computer (152) may remove the contents of the selected document from the sender's allocated portion of the surface (100). Readers will note that, in some embodiments, the surface computer (152) may not render the contents (212) of the selected document on the receiver's allocated portion of the surface (100) until the surface computer (152) receives an acceptance instruction from the receiver (201) that specifies that the receiver is ready to receive the document. Readers will also note that before rendering the contents (212) of the selected document on the receiver's allocated portion of the surface (100), the surface computer (152) may determine whether the receiver is authorized to view the document.

At some point after the surface computer (152) renders the contents (212) of the selected document on the receiver's allocated portion of the surface (100), the surface computer (152) may receive a retrieving instruction from the sender (200) to retrieve the document from the receiver (201). In response to receiving the retrieving instruction, the surface computer (152) may then remove the contents (212) of the selected document from the receiver's allocated portion of the surface (100).

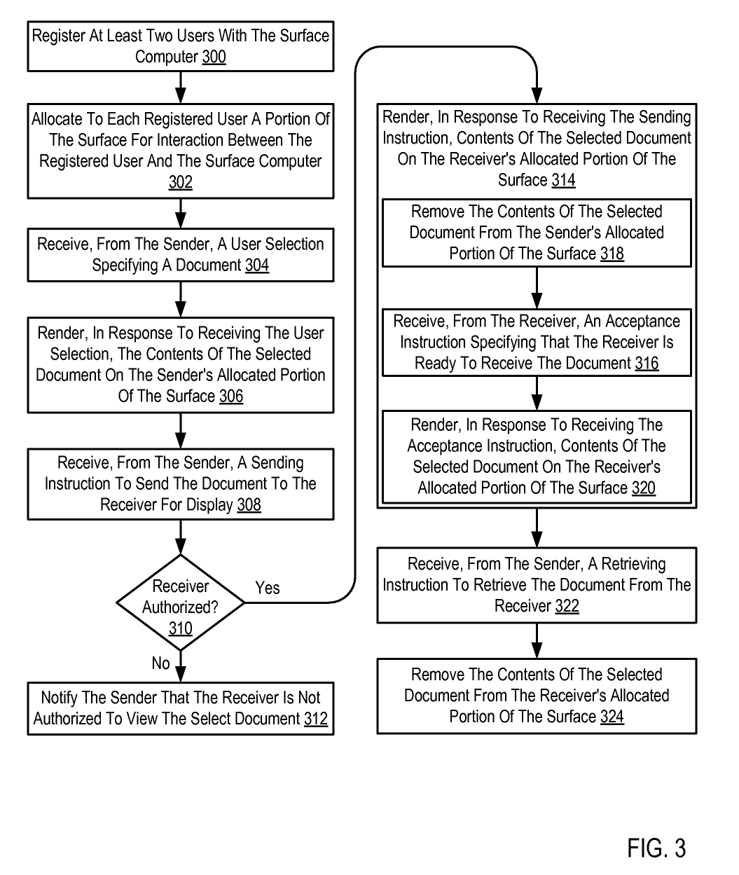

For further explanation, FIG. 3 sets forth a flow chart illustrating an exemplary method of sending a document for display to a user of a surface computer according to embodiments of the present invention. The surface computer includes a surface and is capable of receiving multi-touch input through the surface and rendering display output on the surface. In such a manner, the surface provides an intuitive and efficient mechanism for users to interact with the surface computer.

The method of FIG. 3 includes registering (300) a plurality of users with the surface computer. The plurality of users includes a moderator and a plurality of participants. The moderator is a user of the surface computer who shares a document with other users of the surface computer referred to as the participants. Registering (300) a plurality of users with the surface computer according to the method of FIG. 3 may be carried out by authenticating the identity of a user and determining the user's authorization for using the surface computer. The authentication process may be carried out in variety of ways as will occur to those of skill in the art. For example, the surface computer may render a list of authorized users on the surface to allow the requesting user to select their name from the list. Upon selecting their name, the user may provide a password or other security tokens used for authentication. Consider another example, in which the users are all part of the same team in a company and are using the surface computer to conduct a team meeting. In such an example, the authentication process may be carried out by placing the user's company RFID badge on the surface so that the surface computer may identify the user by comparing security data retrieved from the user's company RFID badge with security data for the user stored in the company's employee database. Still further, other examples of authenticating a user may include the use of biometric authentication such as, for example, voice prints, retinal scans, or fingerprint matching, or the use of public-private key infrastructures.

After authenticating the user, the surface computer may determine the user's authorization for using the surface computer by retrieving access permissions for the authenticated user from the surface computer's authorization policy. The granularity of the access permissions may vary from one embodiment to another. For example, an authorization policy may provide either complete access to the surface computer or no access to the surface computer at all depending on the user's identity. In other embodiments, an authorization policy may provide access to view documents using the surface computer, but no authorization to add, modify, or delete documents. Readers will note that the authorization policy may not assign access permission directly to individual users. Rather, the authorization policy may assign access permissions to a group to which an individual user belongs.

The method of FIG. 3 also includes allocating (302), to each registered user, a portion of the surface for interaction between that registered user and the surface computer. Allocating (302), to each registered user, a portion of the surface for interaction between that registered user and the surface computer according to the method of FIG. 3 may be carried out by identifying a point on the surface that is adjacent to that registered user and defining a region around that identified point for use by that registered user to interact with the surface computer. The surface computer may identify a point on the surface that is adjacent to a registered user by instructing a user to touch the surface directly in front of that user and detecting the location of the user's touch though any number of multi-touch detection technologies such as, for example, surface image processing or frustrated total internal reflection. Other techniques for identifying a point on the surface that is adjacent to a registered user may include inferring a point on the surface that is adjacent to a registered user by triangulation using a set of microphones that capture the user's speech or proximity sensors.

The surface computer may define a region around that identified point by establishing a boundary around the identified point that extends from the edge of the surface toward the center of the surface. Combined with the edge of the surface, the boundary may resemble a rectangle, a semicircle, a triangle, or any other geometric shape. In some embodiments, the surface computer may render a line along the boundary of the region to aid the users in visualizing their portions of the surface through which they may interact with the surface computer. The boundary used to define the region may be fixed or movable by the user. The user may move the boundary by manipulating line rendered on the surface using the user's fingers. For example, if the user wants a larger portion of the surface with which to interact with the surface computer, then the user may drag the boundary line defining the user's portion of the surface away from the user. The surface computer may detect the user's input, recognize the input as an adjustment to the user's boundary, reassign the surface portion to the user based on the boundary adjustment input, and redraw the boundary line at the edge of the user's allocated portion of the surface.

Readers will note that allocating (302), to each registered user, a portion of the surface for interaction between that registered user and the surface computer as described above is carried out using input from the users of the surface computer. In some other embodiments, however, allocating (302), to each registered user, a portion of the surface for interaction between that registered user and the surface computer may be carried out without any user intervention at all. The surface computer may assign a portion of the surface to each user based on user preferences provided in the user's profile such as, for example, the user's preferred location around the surface. In other embodiments, a moderator may provide the surface computer with assignment instructions for each of the users around the surface. Readers will note that the surface computer may adjust the size of each user's allocated portion based on the surface size, the number of users sitting around the surface, and so on.

The method of FIG. 3 includes receiving (304), from the sender, a user selection specifying a document. As mentioned above, the document may be implemented as a word processing document, an image file, a video file, slide show presentation file, XML-based document, and so on. Receiving (304), from the sender, a user selection specifying a document according to the method of FIG. 3 may be carried out by displaying a list of documents or multiple document thumbnails to the sender and detecting a particular hand gesture on the sender's portion of the surface used by the sender to selects a particular document for further data processing. In other embodiments, the surface computer may receive (304) a user selection from the sender that specifies a document according to the method of FIG. 3 by receiving a voice command from the sender that specifies a particular document for further data processing.

Initially, the document may be stored in the surface computer's memory, in data storage across a network, or on a portable computing device placed on the surface of the surface computer. When the document is stored on a portable computing device that is placed on the surface of the surface computer, the surface computer may retrieve the document from the portable computing device by detecting that the computing device is placed on the surface of the surface computer and establishing a data communications connection with the device. The data communications connection may implemented, for example, according to the IEEE 802.11 family of specifications, the Bluetooth family of specifications, the family of specification promulgated by the Infrared Data Association.

The surface computer may detect a portable computing device placed on the surface of the surface computer using any number of multi-touch detection technologies such as, for example, surface image processing or frustrated total internal reflection. Using surface image processing to identify the computing device, for example, the surface computer analyzes an image of the surface to identify the computing device using pattern recognition software. After recognizing the computing device, the surface computer may retrieve connection information from a device data repository used to establish data communications with the computing device placed on the surface. To aid identification of the portable computing device, a small infrared tag may be affixed to the device that provides the surface computer with a device identifier for the device.

Using frustrated total internal reflection technology to identify the computer device, for example, the surface computer is able to detect that a device is placed on the surface. Upon detecting that the device is place on the surface of the surface computer, the surface computer may interrogate the device to retrieve data communication connection information. In some embodiments, the portable computing device may have affixed to it an RFID tag that the surface computer may use to retrieve a device identifier for the device, which in turn may be used by the surface computer to retrieve data communication connection information from a device data repository.

The method of FIG. 3 includes rendering (306), in response to receiving the user selection, the contents of the selected document on the sender's allocated portion of the surface. Rendering (306), in response to receiving the user selection, the contents of the selected document on the sender's allocated portion of the surface according to the method of FIG. 3 may be carried out by orienting the document contents such that the top of the contents are positioned closest to the center of the surface and displaying the oriented document contents on the sender's portion of the surface.

The method of FIG. 3 also includes receiving (308), from the sender, a sending instruction to send the selected document to the receiver for display. The sending instruction directs the surface computer to display the selected document contents on the receiver's portion of the surface. As part of receiving (308) a sending instruction from the sender, the surface computer may receive an identifier for the receiver from the sender. Receiving (308), from the sender, a sending instruction, including receiving an identifier for the receiver, according to the method of FIG. 3 may be carried out by detecting a particular hand gesture on the sender's portion of the surface used by the sender to signal that a particular document is to be sent to particular receiver. For example, the sender may drag a thumbnail view of the document on the sender's portion of the surface to the receiver's name in a list of registered users also displayed on the sender's portion of the surface. In other embodiments, the surface computer may receive (308) a sending instruction, including receiving an identifier for the receiver, according to the method of FIG. 3 by receiving a voice command from the sender that instructs the surface computer to send a particular document to the receiver.

The method of FIG. 3 includes determining (310) whether the receiver is authorized to view the selected document. Determining (310) whether the receiver is authorized to view the document according to the method of FIG. 3 may be carried out by retrieving the receiver's security profile from a security repository and identifying whether the receiver's security profile grants permission to view the contents of the selected document. If the receiver's security profile grants permission to view the selected document contents, then the receiver is authorized to view the selected document. The receiver is not authorized to view the selected document, however, if the receiver's security profile does not grant permission to view the selected document contents.

The method of FIG. 3 includes notifying (312) the sender that the receiver is not authorized to view the contents of the selected document if the receiver is not authorized to view the selected document. Notifying (312) the sender that the receiver is not authorized to view the contents of the selected document according to the method of FIG. 3 may be carried out by rendering a notification message on the sender's portion of the surface to inform the sender that the receiver is not authorized to view the selected document contents.

The method of FIG. 3 includes rendering (314), in response to receiving the sending instruction, contents of the selected document on the receiver's allocated portion of the surface if the receiver is authorized to view the selected document. Rendering (314) contents of the selected document on the receiver's allocated portion of the surface according to the method of FIG. 3 also includes removing (318) the contents of the selected document from the sender's allocated portion of the surface. Removing (318) the contents of the selected document from the sender's allocated portion of the surface according to the method of FIG. 3 may be carried out by deleting the rendered contents of the document from the sender's portion of the surface without removing the other contents that may be displayed in the sender's portion of the surface.

In some embodiments, the surface computer may wait to render the document contents on the receiver's portion of the surface until the surface computer receives an acknowledgement from the receiver. Rendering (314) contents of the selected document on the receiver's allocated portion of the surface according to the method of FIG. 3 therefore includes receiving (316), from the receiver, an acceptance instruction specifying that the receiver is ready to receive the document. The surface computer may receive (316) an acceptance instruction from the receiver according to the method of FIG. 3 by detecting a particular hand gesture on the receiver's portion of the surface used by the receiver to signal that the receiver is ready to receive the document. For example, the receiver may tap a particular location on the receiver's portion of the surface to indicate that the receiver is ready to receive the document. In other embodiments, the surface computer may receive (316) an acceptance instruction from the receiver according to the method of FIG. 3 by receiving a voice command from the receiver that instructs the surface computer that the receiver is ready to receive the document.

Rendering (314) contents of the selected document on the receiver's allocated portion of the surface according to the method of FIG. 3 includes rendering (320), in response to receiving the acceptance instruction, contents of the selected document on the receiver's allocated portion of the surface. Rendering (320), in response to receiving the acceptance instruction, contents of the selected document on the receiver's allocated portion of the surface according to the method of FIG. 3 may be carried out by orienting the document contents such that the top of the contents are positioned closest to the center of the surface and displaying the oriented document contents on the receiver's portion of the surface.

In some embodiment, after the surface computer sends the document to the receiver, the receiver may modify the document, send the document to other users, download the document onto the receiver's portable computer device, and so on. In other embodiments, however, the sender maintains control over the document sent to the receiver. In the method of FIG. 3, for example, the sender is able to retrieve the document from the receiver at the pleasure of the sender. The method of FIG. 3 therefore includes receiving (322), from the sender, a retrieving instruction to retrieve the document from the receiver. Receiving (322), from the sender, a retrieving instruction to retrieve the document from the receiver according to the method of FIG. 3 may be carried out by detecting a particular hand gesture on the sender's portion of the surface used by the sender to instruct the surface computer to retrieve the document from the receiver. For example, on the sender's portion of the surface, the sender may drag a thumbnail of the document away from a region of the sender's portion of the surface that represents the documents sent to the receiver. In other embodiments, the surface computer may receive (322) a retrieving instruction from the sender according to the method of FIG. 3 by receiving a voice command from the sender that instructs the surface computer that the retrieve the document from the receiver.

The method of FIG. 3 includes removing (324), in response to receiving the retrieving instruction, the contents of the selected document from the receiver's allocated portion of the surface. Removing (324), in response to receiving the retrieving instruction, the contents of the selected document from the receiver's allocated portion of the surface according to the method of FIG. 3 may be carried out by deleting the rendered contents of the document from the receiver's portion of the surface without removing the other contents that may be displayed in the receiver's portion of the surface and again rendering the document contents on the sender's portion of the surface.

Readers will note that the description of sending a document for display to a user of a surface computer according to exemplary embodiments above is for explanation above. In fact, readers will note that in some embodiments, when a sender decides a document is to be sent they can make it discoverable. Once the sender has made the document discoverable, a receiver may indicate they are the intended receiver. Alternatively, multiple users may indicate that they wish to receive the document. In still other embodiments, the sender may either specify who is to receive the document or send the document to all users who indicate they wish to receive the document. When receivers indicate that they are the intended receiver, the receiver may indicate that they are the intended recipient through gestures such as, for example, a tap on the surface computer. When senders specify the recipients, senders may choose from a list of available receivers who should receive the document from a drop down menu. In some embodiments, a timer may be associated with the document to allow for a predefined amount of time that the document can be shared.

Readers will note that sending a document for display to a user of a surface computer according to embodiments of the present invention as described above advantageously provides a common interface for viewing and manipulating a document among a group of users. Providing a common interface for interacting with personalized documents has performance advantages over traditional systems that employ multiple network-connected devices because network overhead is substantially reduced and real-time collaborative usability is enhanced.

Exemplary embodiments of the present invention are described largely in the context of a fully functional computer system for sending a document for display to a user of a surface computer. Readers of skill in the art will recognize, however, that the present invention also may be embodied in a computer program product disposed on a computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of sending a document for display to a user of a surface computer, the surface computer comprising a surface, surface computer capable receiving multi-touch input through the surface and rendering display output on the surface, the method comprising:
registering at least two users with the surface computer, the users including a sender and a receiver;
allocating to each registered user a portion of the surface for interaction between the registered user and the surface computer;
receiving, from the sender, a user selection specifying a document;
receiving, from the sender, a sending instruction to send the selected document to the receiver for display; and
rendering, in response to receiving the sending instruction, contents of the selected document on the receiver's allocated portion of the surface.

2. The method of claim 1 further comprising rendering, in response to receiving the user selection, the contents of the selected document on the sender's allocated portion of the surface, wherein rendering contents of the selected document on the receiver's allocated portion of the surface further comprises removing the contents of the selected document from the sender's allocated portion of the surface.

3. The method of claim 1 further comprising:
receiving, from the sender, a retrieving instruction to retrieve the document from the receiver; and
removing, in response to receiving the retrieving instruction, the contents of the selected document from the receiver's allocated portion of the surface.

4. The method of claim 1 wherein rendering, in response to receiving the sending instruction, contents of the selected document on the receiver's allocated portion of the surface further comprises:
receiving, from the receiver, an acceptance instruction specifying that the receiver is ready to receive the document; and
rendering, in response to receiving the acceptance instruction, contents of the selected document on the receiver's allocated portion of the surface.

5. The method of claim 1 wherein receiving, from the sender, a sending instruction to send the document to the receiver for display further comprises receiving, from the sender, an identifier for the receiver.

6. The method of claim 1 further comprising determining whether the receiver is authorized to view the selected document, wherein rendering, in response to receiving the sending instruction, contents of the selected document on the receiver's allocated portion of the surface further comprises rendering the contents of the selected document on the receiver's allocated portion of the surface if the receiver is authorized to view selected the document.

7. The method of claim 1 wherein the sender or the receiver is a remote user.

8. A surface computer for sending a document for display to a user of a surface computer, the surface computer comprising a surface, surface computer capable of receiving multi-touch input through the surface and rendering display output on the surface, the surface computer comprising a computer processor, a computer memory operatively coupled to the computer processor, the computer memory having disposed within it computer program instructions capable of:
registering at least two users with the surface computer, the users including a sender and a receiver;
allocating to each registered user a portion of the surface for interaction between the registered user and the surface computer;
receiving, from the sender, a user selection specifying a document;
receiving, from the sender, a sending instruction to send the selected document to the receiver for display; and
rendering, in response to receiving the sending instruction, contents of the selected document on the receiver's allocated portion of the surface.

9. The surface computer of claim 8 wherein:
the computer memory has disposed within it computer program instructions capable of rendering, in response to receiving the user selection, the contents of the selected document on the sender's allocated portion of the surface; and
rendering contents of the selected document on the receiver's allocated portion of the surface further comprises removing the contents of the selected document from the sender's allocated portion of the surface.

10. The surface computer of claim 8 wherein the computer memory has disposed within it computer program instructions capable of:
receiving, from the sender, a retrieving instruction to retrieve the document from the receiver; and
removing, in response to receiving the retrieving instruction, the contents of the selected document from the receiver's allocated portion of the surface.

11. The surface computer of claim 8 wherein rendering, in response to receiving the sending instruction, contents of the selected document on the receiver's allocated portion of the surface further comprises:
receiving, from the receiver, an acceptance instruction specifying that the receiver is ready to receive the document; and
rendering, in response to receiving the acceptance instruction, contents of the selected document on the receiver's allocated portion of the surface.

12. The surface computer of claim 8 wherein:
the computer memory has disposed within it computer program instructions capable of determining whether the receiver is authorized to view the selected document; and
rendering, in response to receiving the sending instruction, contents of the selected document on the receiver's allocated portion of the surface further comprises rendering the contents of the selected document on the receiver's allocated portion of the surface if the receiver is authorized to view selected the document.

13. A computer program product for sending a document for display to a user of a surface computer, the surface computer comprising a surface, surface computer capable of receiving multi-touch input through the surface and rendering display output on the surface, the computer program product disposed in a computer readable medium, the computer program product comprising computer program instructions capable of:
registering at least two users with the surface computer, the users including a sender and a receiver;
allocating to each registered user a portion of the surface for interaction between the registered user and the surface computer;
receiving, from the sender, a user selection specifying a document;
receiving, from the sender, a sending instruction to send the selected document to the receiver for display; and
rendering, in response to receiving the sending instruction, contents of the selected document on the receiver's allocated portion of the surface.

14. The computer program product of claim 13 further comprising computer program instructions capable of rendering, in response to receiving the user selection, the contents of the selected document on the sender's allocated portion of the surface, wherein rendering contents of the selected document on the receiver's allocated portion of the surface further comprises removing the contents of the selected document from the sender's allocated portion of the surface.

15. The computer program product of claim 13 further comprising computer program instructions capable of:
receiving, from the sender, a retrieving instruction to retrieve the document from the receiver; and
removing, in response to receiving the retrieving instruction, the contents of the selected document from the receiver's allocated portion of the surface.

16. The computer program product of claim 13 wherein rendering, in response to receiving the sending instruction, contents of the selected document on the receiver's allocated portion of the surface further comprises:
receiving, from the receiver, an acceptance instruction specifying that the receiver is ready to receive the document; and
rendering, in response to receiving the acceptance instruction, contents of the selected document on the receiver's allocated portion of the surface.

17. The computer program product of claim 13 wherein receiving, from the sender, a sending instruction to send the document to the receiver for display further comprises receiving, from the sender, an identifier for the receiver.

18. The computer program product of claim 13 further comprising computer program instructions capable of determining whether the receiver is authorized to view the selected document, wherein rendering, in response to receiving the sending instruction, contents of the selected document on the receiver's allocated portion of the surface further comprises rendering the contents of the selected document on the receiver's allocated portion of the surface if the receiver is authorized to view selected the document.

19. The computer program product of claim 13 wherein the computer readable medium comprises a recordable medium.

20. The computer program product of claim 13 wherein the computer readable medium comprises a transmission medium.
